(19) United States
(12) Patent Application Publication
(10) Pub. No.: US 2009/0124382 A1
(43) Pub. Date: May 14, 2009

(54) Interactive image projection system and method

(76) Inventors: David Lachance, Lanoraie (CA); Ernest Yale, Repentigny (CA)

Correspondence Address: Franz BONSANG;c/o EQUINOX PROTECTION, 410 - 1500, Du College, St-Laurent, QC, H4L 5G6, CA

(21) Appl. No.: 11/979,965

(22) Filed: Nov. 13, 2007

(51) Int. Cl. A63F 13/00; G03B 21/14; G06F 3/041

(52) U.S. Cl. 463/34; 353/28; 345/173

(57) ABSTRACT

An interactive image projection system and method provides for projection of an interactive image on a projection surface. A copy of the image is broadcast by two projectors onto the projection surface in registration with one another to form a single projection copy on the surface. Sensors on the surface detect a position on the projection surface of an object manipulatable by a user and a computing device connected to the object generates an output in response thereto. The projectors are configured such that any shadow cast by the object in the path of a projection from one projector is at least partially eliminated by the projection of the other projector.

### FIELD OF THE INVENTION

The present invention relates to systems and methods for projecting images, and is more specifically concerned with systems and methods for projecting an interactive image.

### BACKGROUND OF THE INVENTION

It is well known in the art to use projectors to project images on to surfaces and to change the image in response to the position of an input on the surface top project an interactive image responsive to the input. Such systems may include presentation and gaming systems in which an image of a presentation or game is projected onto a surface and subsequently modified in response to inputs on the surface or in a projection area in which the image is projected.

For example, U.S. Pat. No. 7,170,492, issued to Bell on Jan. 30, 2007 teaches an interactive video display system in which an image is projected onto a display surface. A plurality of cameras above the display surface detect the position of an object, for example a person, on or above the surface. Based on the position, the image is then modified, for example by a combination of software and hardware, rendering the image interactive.

Similarly, U.S. patent application Ser. No. 10/737,730, filed by Bell and published on Sep. 23, 2004 discloses an interactive directed light/sound system in which an image is projected by a projector onto a mirror which reflects the image onto a surface therebelow. A camera detects the position of an object in an area on or near the surface and the image is the modified on the basis of the position, once again rendering the image interactive.

U.S. Pat. No. 5,951,015, issued to Smith et al. on Sep. 14, 1999 teaches a game apparatus in which objects are thrown against a display surface having contact sensitive sensors connected thereto and upon which an image containing target portions of the image is projected by a projector. When an object contacts the surface in a position in which a target portion of the image is currently projected, an output, such as a change in the image, is generated by a computing device which generates the image for the projector the image is changed, thereby rendering the image interactive.

While the systems and methods described in the aforementioned references provide interactive images for games and other applications, the image provided thereby is often partially blocked or occluded by the shadow cast by the user or an object manipulated thereby in proximity to the surface upon which the image is projected. This hiding of the image may lead to errors by the user caused by an inability to see part of the image. It may also lead to frustration and reduced enjoyment by the user when attempting to interact with the image, especially when the image is used as part of a game. It may also be frustrating for spectators or observers of the interactive image when a portion of the image is hidden by a shadow of the user.

Accordingly, there is a need for an improved system and method for projecting an interactive image.

### SUMMARY OF THE INVENTION

It is therefore a general object of the present invention to provide an improved system and method for projecting an interactive image.

An advantage of the present invention is that the system and method provides an interactive image for which the shadows of objects situated on or in proximity to an image portion of a projection surface upon which the image is projected are reduced.

Another advantage of the present invention is that the interactive image provided thereby is easily used for a game in which a player user is situated on or proximally above the projection surface.

According to a first aspect of the present invention, therein is provided an interactive image projection system comprising:
a projection surface;
at least one sensor connected to the projection surface for detecting an object position of an object manipulatable by a user when the object is situated on the projection surface;
a computing device connected to the sensor for receiving the object position and generating at least one output in response thereto; and
first and second projectors disposed vertically above the projection surface and generally opposed to one another, the first and second projectors being configured for respectively projecting first and second respective projections of, respectively, first and second copies of an image onto the projection surface in register with one another as a single projected copy of the image thereon with each respective projection at least partially eliminating any shadow cast by the object on the image portion by blocking the other the respective projection.

In a second aspect of the present invention, there is provided a method for projecting an interactive image, the method comprising the steps of
a) projecting respective first and second projections of, respectively, first and second copies of an image onto a projection surface in register with one another to form a single projected copy of the image on the projection surface with, respectively, first and second projectors positioned vertically thereabove and generally opposite one another, each respective at least partially eliminating any shadow cast by the object on the projection surface by blocking the other the respective projection;
b) detecting an object position on the projection surface of an object manipulatable by a user with at least one sensor connected to the projection surface; and
c) based on the object position, generating at least one output with the computing device.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a partially exploded top perspective view of an embodiment of an interactive image projection system in accordance with the present invention;

FIG. 2 is a side perspective view of the embodiment shown in FIG. 1;

FIG. 2a is a side perspective view showing projection of the image in conjunction with mirrors for the embodiment shown in FIG. 1;

FIG. 3 is a top plan view of a projection surface and projectors of the embodiment shown in FIG. 1, illustrating reduction of shadows of an object on the projection surface;

FIG. 4 is a top view of the projection surface, showing sensors connected therebelow, for the embodiment shown in FIG. 1; and

FIG. 5 is schematic view of the embodiment shown in FIG. 1.

### DETAILED DESCRIPTION OF THE PREFERRED EMBODIMENTS

With reference to the annexed drawings the preferred embodiments of the present invention will be herein described for indicative purpose and by no means as of limitation.

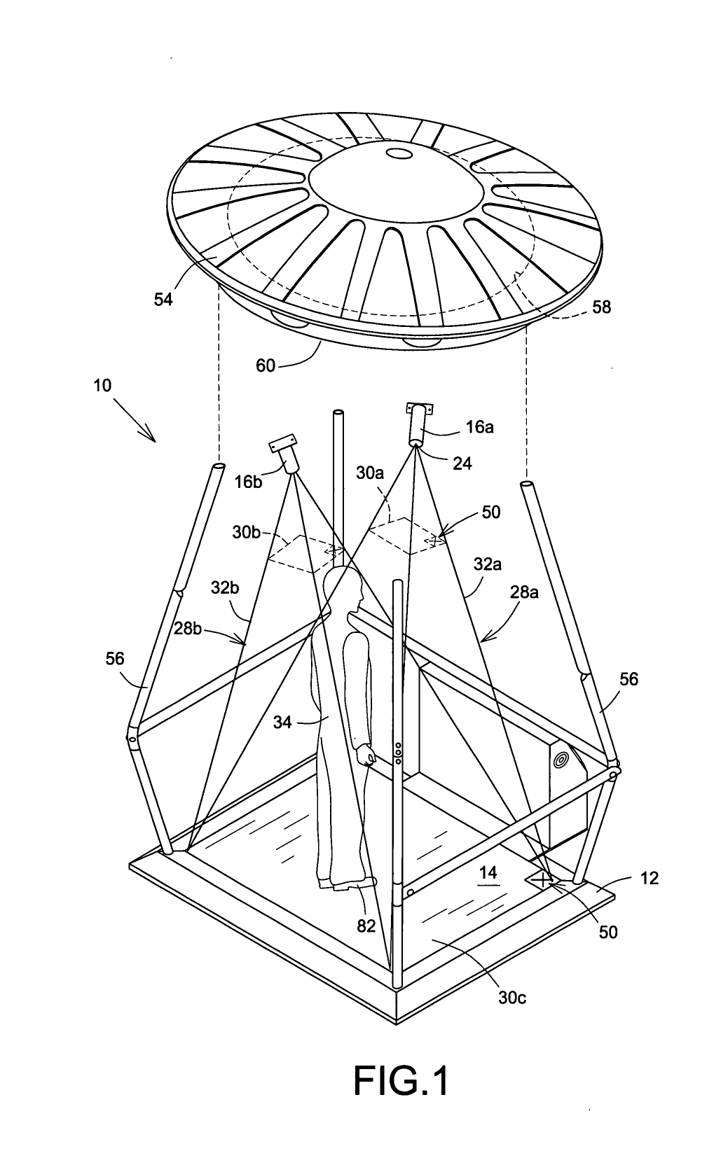

Referring now to FIGS. 1 through 5, there is shown an embodiment of a system, shown generally as 10, in accordance with the present invention. Generally speaking the system 10 consists of a platform 12, a projection surface 14 extending across at least a portion thereof and having at least one sensor 18 connected thereto, at least two projectors 16, and a computing device 20 connected to the sensor 18.

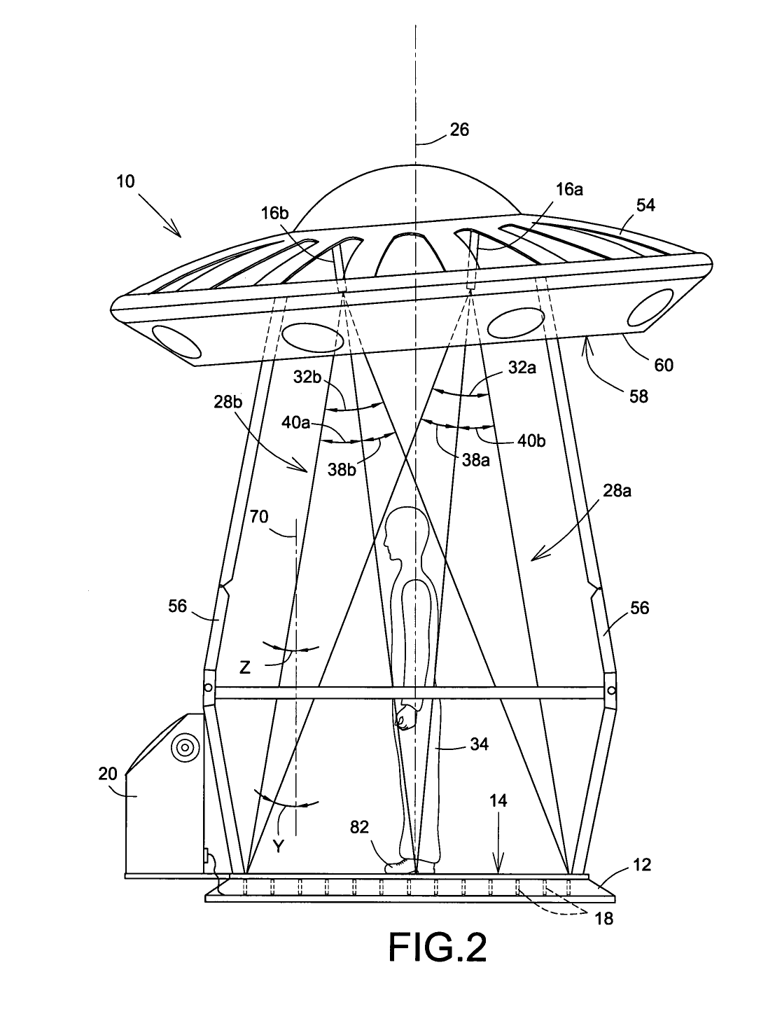

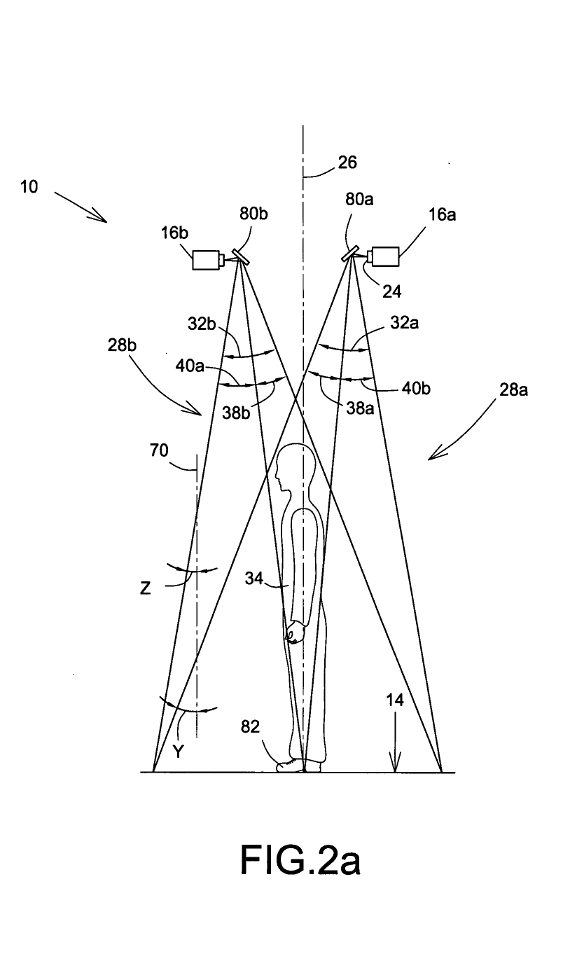

As shown in FIGS. 1 and 2, the projection surface 14 is preferably flat and preferably rectilinear in shape. First and second projectors, respectively 16a and 16b, are mounted, for example suspended, above the projection surface 14 and are configured such that they respectively project first and second projections, shown generally as 28a and 28b, of first and second copies 30a, 30b of an image 30 onto at least a portion the projection surface 14. For example, and as shown in FIGS. 1 and 3, the projectors 16a, 16b may be positioned vertically above the projection surface 14 with the projecting lens 24 thereof facing downwardly towards the projection surface 14. The copies 30a, 30b of the image 30 are, when projected on the projection surface 14, preferably of the same shape, i.e. preferably rectilinear, as the projection surface 14. The projectors 16a, 16b are positioned generally opposite one another, for example vertically above opposing sides 22 of the projection surface, preferably aligned directly opposite one another as shown. More specifically, the projectors 16 are configured for projection, for example positioned, off-axis relative to a centre axis 26, or centerline, of the projection surface 16, on opposite sides 22 of the centerline such that the first and second projectors 16a, 16b project, respectively, first and second copies 30a, 30b, of the image 30 in register with one another onto the projection surface 14. Thus, the copies 30a, 30b register with one another, i.e. appear, on the projection surface 14 as a single projected copy 30c of the image 30 on the projection surface 14. The projectors 16 may be configured to project off centre both in the horizontal and vertical planes. The projected copy 30c serves as a visual interface for the user of an application 48, for example a game, stored on the computing device 20 and controlled thereby.

Reference is now made to FIG. 2a. Alternatively, the projectors 16a, 16b could be configured to project respectively the first and second projections 28a, 28b of, respectively, the first and second copies 30a, 30b onto first and second mirrors 80a, 80b for reflection thereby of the projections 28 of the copies 30a, 30b onto the projection surface 14. Thus, as shown in FIG. 2a, the projections 28 of the copies 30a, 30b of the image are indirectly projected onto the projection surface 14 via the mirrors 80. For example, as shown, the projectors 16a, 16b could each positioned or oriented such that the lens 24 projects, respectively, the copy 30a, 30b of the image 30 substantially horizontally onto, respectively the mirror 80a, 80b. Each mirror 80a, 80b is positioned at an angle, for example 45 degrees, relative the projection surface 14 such that the projections 28a, 28b of the copies 30a, 30b are projected, by reflection from the mirrors 80a, 80b onto the projection surface in register with one another to form the single projected copy 30c of the image 30 thereupon, in the same manner as shown in FIGS. 1 and 2. Apart from the reflection of the projections 28a, 28b of copies 30a, 30b by mirrors 80a, 80b, and the positioning of the projectors 16, the functioning of the system 10 is the same as in FIGS. 1 and 2. It should be noted that the angles and positions of the mirrors 80 and projectors 16 need not be identical to those shown in FIG. 2a. Rather, any configuration of the mirrors 80 and projectors 16 that permits the first and second copies 30a, 30b to be reflected from the mirrors 80 in register with one another as the single projected copy 30c on the projection surface 14.

Reference is now made to FIGS. 2, 2a, and 3. As mentioned above, the copies 30a and 30b are projected off-axis from opposing sides 22 of the centre line to register with one another as a single copy image 30c on the projection surface 14. Thus, for any blocked portion 38a, and resulting shadow, of the projection 28a of the copy 30a by projector 16a that is blocked by an object 34, or portion 82 thereof, situated in the projection volume 32a of the projector 16a, a corresponding illuminated portion 40a of the projection volume 32b of the second projection 28b of the second copy 30b, identical in appearance on the projection surface 14 to the blocked portion 38a, will be projected onto the projection surface 14 and at least partially visible thereupon and/or on the object 34, or portion thereof 82, if situated proximal to the surface 14. Similarly, for any blocked portion 38b, and resulting shadow, of the projection 28b of the copy 30b by projector 16b that is blocked by an object 34, 82 situated in the projection volume 32b of the projector 16b, a corresponding illuminated portion 40b of the projection volume 32a of the first projection 28a of the first copy 30a, identical in appearance on the projection surface 14 to the blocked portion 38b, will be projected onto the projection surface 14 and at least partially visible thereupon and/or on the object 34, 82 if situated proximal to the surface 14. Thus, the projection 28 of each copy 30a, 30b at least partially eliminates any shadow cast by the object 34 on the projection surface 14 resulting from blocking of the projection 28 of the other copy 30b, 30a.

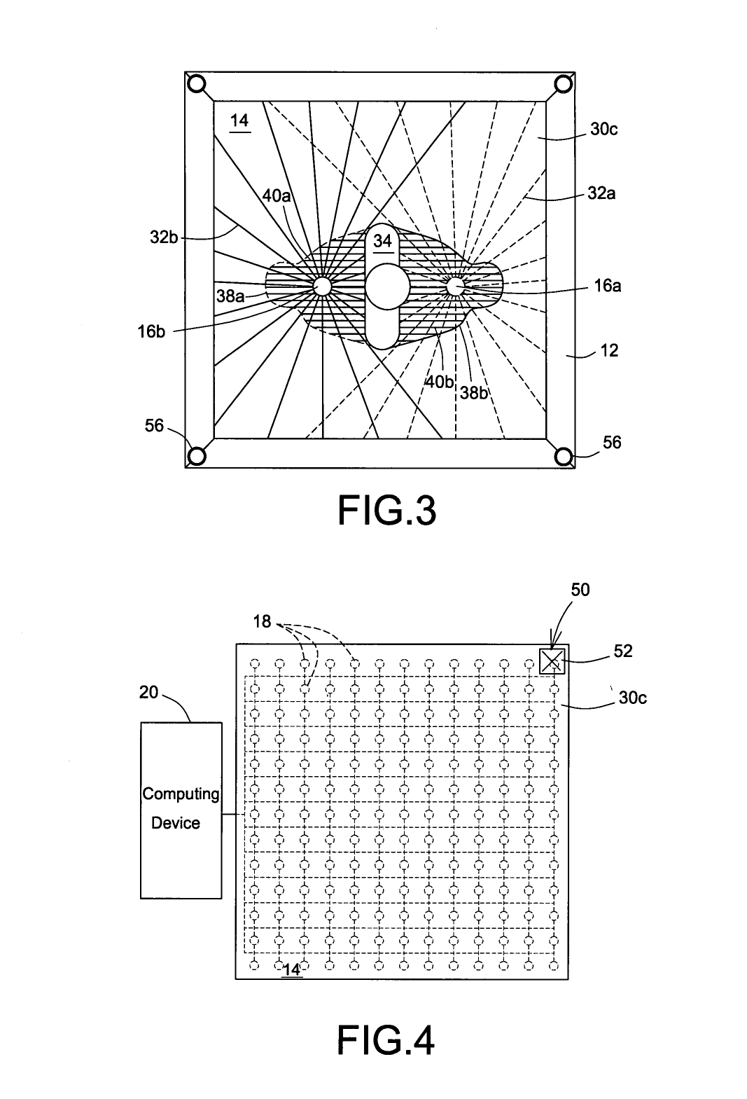

Referring now to FIGS. 2, 2a and 4, the projection surface 14, for example a floor or carpet, is connected to at least one sensor 18, shown in dotted lines, preferably disposed on or underneath the projection surface 14, or incorporated therein. The sensor 18 detects the presence and position of an object 34 or an object portion 82 thereof, referred to as an object position for the purposes of this description, on the projection surface 14. The object may, for example, be a user 34 with the object portion thereof being a body part 34 of the user, for example the user's foot 34. The object 34 could also be any other object 34 manipulatable by the user, for example a stick, a ball, or the like.

Referring now to FIGS. 2, 2a, 4, and 5, each position on the projection surface 14 that is detectable by the sensor 18 corresponds to a corresponding virtual position in a mapping 46, stored in the computing device 20, of the projection surface 14 and, optionally, of a computer copy 30c of the image 30 stored and, optionally, generated by the computing device 20. When the sensor 18 detects the object 34, and the object position thereof, on the projection surface 14, the sensor 34 transmits the object position, as a user input for the application 48, to the computing device 20. The computing device 20, and more specifically the application 48, receives the object position and then maps the object position to the corresponding virtual position in the mapping 46 to identify the position of the object 34 relative to the mapping 46.

Referring again to FIGS. 2, 2a, 4, and 5, the sensor 18 deployed by the system 10 to detect the object position of the object 34 may be of a variety of types. Further, the system 10 may deploy are plurality of sensors 18, each sensor sensing the presence of the object 34 or object portion 82 thereof when the object 34 or portion 82 is situated on a corresponding sensor portion for the sensor 18 on the projection surface 14. For example, the system 10 may have a plurality of contact or pressure sensors 18 disposed beneath the projection surface 16 and connected thereto. When deployed in the system 10, the pressure sensor 18 is actuated by a pressure exerted by the mass of the object when placed on the surface 14 to detect the object position. As an alternative example, and particularly useful when the object 34 is the user 34 or a body part 82 thereof, for example the users foot 34, the system 10 could deploy a deploy a plurality digital-charge transfer capacitance touch sensors 18, such as a plurality of Qmatrix™ sensors manufactured by Quantum Research Group™ of Hampshire, United Kingdom. Such touch sensors 18 emit an electromagnetic field as a series of digital pulses with a first electrode for reception by a second electrode, not shown. Human contact or proximity to the sensor 18 absorbs a portion of the digital pulses and reduces the strength of the field. Thus, when the touch sensor 18 detects, via the second electrode, that the field emitted thereby, i.e. the first electrode, has been reduced, the touch or proximity of a human being, namely the user 34 or a body part 82 thereof, has been detected. Based on the position of the touch sensor 18 which detects the presence of the user 34 or a body part 82 thereof, for example the user's foot 82, the object position is detected.

Further, if desired, each sensor 18, whether a pressure sensor 18 or touch sensor 18 described above, could correspond to a virtual position, for example pair of (x,y) coordinates, in the mapping 46 of the projection surface 16 and, optionally, a computer copy 30d of the image 30 stored on the computing device 20. Alternatively, in the case where the sensor 18 deployed is a pressure sensor 18, there could be a single pressure sensor 18 which may detect the object position of the object 34 anywhere on the projection surface 14. While the sensor 18 is preferably a pressure or touch sensor 18, as described above, the sensor could be any type of sensor, for example photo sensors, infrared sensors, cameras, or the like, capable of detecting the object position of the object 34 or portion 82 thereof on the projection surface 14 and communicating the object position to the computing device 20.

Based on the virtual position in the mapping 46 corresponding to the object position detected by the sensor 18, the computing device 20 determines whether one or more outputs is required and, if required, generates the outputs. The output may include any output to the user or any output used for subsequent processing by the application 48 that is appropriate to the domain of the application 48. For example, in cases where the application 48 is a game 48, the computing device 20 could, for the output, generate a sound, award points to the user, deduct points from the user, generate a visual effect, terminate the game 48, or simply proceed with the game 48.

The image 30 may include one or more target portions, shown generally as 50, which represent a respective target, for example an X as shown in FIGS. 1 and 4, for the user and which is mapped in the mapping 46 to a corresponding target position 52, on the projection surface 14 where the target portion 50 is projected for a predefined duration at a predefined moment. When the object 34 is placed on the target position 52, and thereby the target portion 50 of the projected copy 30c, the object position detected by the sensor 18 corresponds, i.e. is identified by the application 48 by consultation with the mapping 46, to the target position 52 and the application 48 determines that the object 34 is positioned on the target portion 50 representing the target on the projection surface 14.

Provided the computing device 20, and more specifically the application 48 and mapping 46, are programmed or updated to take into account any changes to the image 30 and target portions 50, whether or not based on user inputs such as the object position, it is not necessary that the image 30 be stored on the computing device 20 or that the computing device 20, and more specifically the application 48, generate the image 30. For example, the image 30 could be projected and modified as a series of images 30 on first and second copies of a film projected by the two projectors 16a, 16b, with the application 48 and mapping 46 being time synchronized with the film to update the target positions 52 and target portions 50 in the mapping 48 as the film progresses. Optionally, but preferably, the projectors 16 are connected to the computing device 20 which generates the first and second copies 30a, 30b and transmits them thereto for projection as the single projected copy 30c on the projection surface 14. Thus, preferably, the computing device 20, for example the application 48, generates, and updates, the image 30, including a computer copy 30d and the first and second copies 30a, 30b, as well as the mapping 46. For example, the computing device 20 could generate, as an output, an updated or modified image 30, specifically modified copies 30a, 30b, 30d, along with modified target portions 50 and target positions 52, and an updated mapping 46 for subsequent projection of the modified copies 30a, 30b onto the projection surface 14 as a modified projected copy 30c.

Use of target portions 50 and generation of the image 30 by the computing device 20 are particularly useful where the application 48 is game 48. For example, and as shown for the exemplary embodiment in FIGS. 1-5, the application 48 could be a game 48 in which the visual interface for the game 48 is the projected copy 30c projected onto the projection surface 14, for example a floor 14. At a predefined time, the image 30, generated by the computing device 20, could have one or more target portions 50 representing targets which are projected onto corresponding target positions 52 on the floor 14, with the goal of the game being that the user position the object 34 or object portion 82 on the target positions 52, and thereby the projected targets shown in the target portions 50, to obtain points and continue to play the game 48. For example, the object 34 could be the user's body 34 or a part 82 thereof, for example the user's foot 82, in which case the points would be obtained by the user stomping on the target positions 52 with his or her foot 82. When the user's foot 82, or other object, is placed on the target position 52, the computing device 20, more specifically the application 48, determines, via the mapping 46, that the object position of the foot 82 received from the sensor 18 corresponds to the target position 52 for the target portion 50, and thus generates an output, for example a sound, visual effect, an award of points to a score for the user, and/or a modified image 30 with updated target portions 50 for subsequent projection to continue the game 48. The speed at which the image 30 and target portions 50 are updated may also be updated, for example increased, as the game 48 progresses. While the target portions 50 are shown as an X in the drawings, it will be apparent to one skilled in the art that the target portions 50 could contain any image appropriate for the game 48. Advantageously, as the first and second copies 30a, 30b are projected in register with one another to form the single projected copy 30c, shadows cast by the object 34, in this case the user's body 34 and foot 82, are reduced. Accordingly, the risk of shadows from the user 34 occluding the visibility of the projected copy 30c, and in particular the target portions 50, which would reduce playability of the game and enjoyment thereof by the user, is reduced.

The projectors 16a, 16b may be mounted directly oppositely across from one another and vertically above the projection surface 14, i.e. the floor 14 of the platform 12, in an optional roof structure 54, shown in FIGS. 1 and 2. The roof structure 54 extends vertically above the projection surface 14, supported by supporting members 56 connected to the platform 12 outside the projection surface 14 and which extend upwardly vertically away therefrom. While four supporting members 56 are shown, a single supporting member 56 may be sufficient provided the single supporting member 56 is capable of supporting the roof structure in extension above the platform 12 as shown. The roof structure 54 has a roof aperture 58 on a lower roof portion 60 which faces towards the projection surface 14. The aperture 60 and projectors 16 are configured, i.e. sized, shaped and/or positioned, such that the copies 30a, 30b of the image 30, are projected therethrough without blocking or occlusion thereof by the lower roof portion 60, thereby preventing undesired shadows of the lower roof portion being cast onto the projected copy 30c. However, the roof structure 54, as well as the support members 56, may also be omitted provided that the projectors 16 are positioned above the projection surface 14 and configured to project the copies 30a, 30b in registration with one another on the projection surface 14 to form the single projected copy 30c on the projection surface 14. The roof structure 54 could also be deployed with the configuration shown in FIG. 2a, provided the projectors 16 and mirrors 80 are configured, for example positioned, such that the projections 28a, 28b reflected form the mirrors 80a, 80b are not obstructed by the structure 54.

Referring still to FIGS. 1, 2, 2a and 4, for the specific embodiment shown, the projectors 16a, 16b are spaced above the projection surface 14 at sufficient height to be located above the object 34, in this case, the user 34. For example, for the embodiment shown, the projectors could be placed at a height of 7.5 to 8 feet to ensure that they are situated above an adult user 34 when in a standing upright position. Further, and again for the specific embodiment shown, the projectors 16 are configured to project the copies 30a, 30b at an angle Z of approximately 5 degrees relative to an axis 70 perpendicular to the surface 14 on one side of the image 30 and an angle Z of approximately 55 degrees relative the axis 70 on an opposite side of the image 30. However, other configurations for the angles Y and Z relative the axis 70 are possible, as are other projectors heights and positions, for different applications depending on the relative location and size of the projection surface 14 and the size of the object 34, provided that the copies 30a, 30b projected form a single copy 30c of the image 30 on the projection surface 14. Further, if desired, the sensors 18, and target portions 50, could each be sized to approximate, on the projection surface 14, the typical largest size of the object 34. For example, where the system 10 is deigned to detect the position of the user's foot 82 as the object position, the sensors 18 could be rectangularly shaped and of approximately 12 inches by 4 inches in dimension, with the target portions 50 similarly sized and shaped when projected onto the projection surface 14. However, if desired, the sensors 18 could be sized to be smaller than the largest size of the object 34 or portion 82, for example 4 inches by 4 inches when the position to be detected is that of the users foot 82.

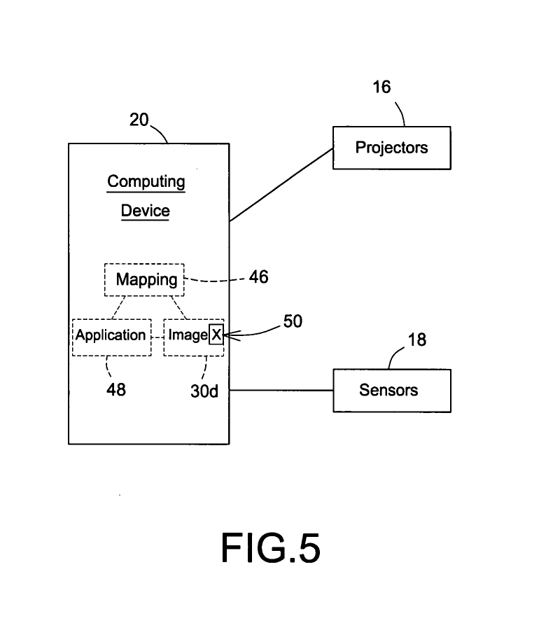

Referring to FIG. 5, the computing device 20 is preferably a computer situated proximal the platform 12 or the support members 56. However, the computing device 20 could also be situated remotely from the platform 12 and projectors 16, provided it is connected to the sensors 18 and, if required, the projectors 16. Further, the computing device 20 may be any computing device 20 capable of connection to the sensors 18 and, if required, the projectors 16, and of processing the object positions received, the application 48 and mapping 46, and, if required, of generating the image 30 and copies 30a, 30b, 30c thereof and target portions 50.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. An interactive image projection system, comprising:
a projection surface;
at least one sensor connected to said projection surface for detecting an object position of an object manipulatable by a user when said object is situated on said projection surface;
a computing device connected to said sensor for receiving said object position and generating at least one output in response thereto; and
first and second projectors disposed vertically above said projection surface and generally opposed to one another, said first and second projectors being configured for respectively projecting first and second respective projections of, respectively, first and second copies of an image onto said projection surface in register with one another as a single projected copy of the image thereon with each respective projection at least partially eliminating any shadow cast by said object on said image portion by blocking the other said respective projection.

2. The system of claim 1, wherein said projection surface is a floor and said object is one of a body of said user a body part thereof.

3. The system of claim 1, wherein said at least one sensor is a pressure sensor, said pressure sensor detecting said object position by sensing a pressure exerted by a mass of said object at said object position on said projection surface.

4. The system of claim 1, wherein said first, second, and projected copies are rectilinear.

5. The system of claim 1, further comprising a roof structure mounted above said projection surface, and having a roof aperture facing towards said projection surface, said projectors being mounted in said roof structure and configured for respectively projecting said respective first and second projections through said aperture without blockage thereof by said roof structure.

6. The system of claim 2, wherein said projectors are positioned at a height, relative said projection surface, to extend vertically above said user in a standing position on said floor.

7. The system of claim 5, further comprising at least one support member extending from outside of said projection surface and upwardly away therefrom, said roof structure being mounted on said at least one support member.

8. The system of claim 1, wherein said projected copy is a visual interface for a computer application stored on and controlled by said computing device, said computing device receiving said object position as a user input for said application.

9. The system of claim 8, wherein a mapping of said projection surface is stored on said computer, said computing device identifying said object position relative to said mapping and generating said at least one output based upon said object position in said mapping.

10. The system of claim 9, wherein said projectors are connected to said computing device, said computing device generating said image and said mapping and transmitting said first and second copies of said image to, respectively, said first and second projectors for projection thereby.

11. The system of claim 3, wherein said at least one pressure sensor is a plurality of pressure sensors.

12. The system of claim 10, wherein said computing device modifies said image based on said object position, thereby generating a modified image and modified first and second copies thereof for subsequent projection by, respectively, said first and second projectors as said at least one output.

13. The system of claim 9, wherein said application is a game and said image comprises at least one target portion having a respective target represented therein, said computing device detecting when said object position corresponds to a target position on said projection surface where said target portion is projected.

14. The system of claim 9, wherein said at least one sensor includes a plurality of sensors, each sensor being configured for detecting a presence of said object on a respective sensor portion for said sensor on said surface.

15. The system of claim 13, wherein said computing device adds, as said at least one output, a respective amount of points for said target to a score for said user when said object position corresponds to said target position.

16. The system of claim 10, wherein said mapping maps said projection surface to said image stored on said computing device, said mapping comprising, for each said object position detectable by said at least one sensor, at least one respective corresponding virtual position in said image.

17. A method for projecting an interactive image, said method comprising the steps of:
a) projecting respective first and second projections of, respectively, first and second copies of an image onto a projection surface in register with one another to form a single projected copy of said image on said projection surface with, respectively, first and second projectors positioned vertically thereabove and generally opposite one another, each respective at least partially eliminating any shadow cast by said object on said projection surface by blocking the other said respective projection;
b) detecting an object position on said projection surface of an object manipulatable by a user with at least one sensor connected to said projection surface; and
c) based on said object position, generating at least one output with said computing device.

18. The method of claim 17, wherein said computing device is further connected to said projectors, said method further comprising the steps of, prior to said step of projecting;
d) generating said image on said computing device; and
e) transmitting said first and second copies of said image to, respectively, said first and second projectors.

19. The method of claim 18, wherein said step of generating said at least one output comprises modifying, based on said object position, said image and said first and second copies thereof for subsequent projection.

20. The method of claim 18, wherein said step of generating said image comprises generating a target portion thereof representing a target and having a target position on said projection surface associated therewith and said step of generating at least one output comprises awarding points to said user if said object position is within said target position and modifying said image and said first and second copies thereof to generate a new target portion and a new target position therefore for subsequent projection by said first and second projectors.

21. The method of claim 16, further comprising, prior to said step of projecting, the step of generating a mapping comprising, for each possible said object position detectable by said sensor, at least one corresponding respective virtual position in said image, said step of generating at least one output comprising determining said corresponding respective virtual position for said object position detected by said sensor.

22. The system of claim 1, wherein said object is a human being or a body part of a human being and said at least one sensor is a plurality of digital-charge transfer capacitance touch sensors, said touch sensors emitting an electromagnetic field and detecting said object position by a detecting a position of a reduction in said electromagnetic field caused by at least partial thereof by said object.

23. The system of claim 1, further comprising first and second mirrors, said first projector and said second projector and said first and second mirrors being configured for projecting of said first projection by said first projector onto said first mirror and projection of said second projection onto said second mirror and for reflections of said first and second projections thereby onto said projection surface in register with one another as said projected copy.
